(19) United States
(12) Patent Application Publication
(10) Pub. No.: US 2026/0158985 A1
(43) Pub. Date: Jun. 11, 2026

(54) HEIGHT ADJUSTABLE CUP HOLDER

(71) Applicants: HYUNDAI MOTOR COMPANY, Seoul (KR); KIA CORPORATION, Seoul (KR); ESP CO.,LTD, Ulsan (KR); SEOYON E-HWA CO., LTD., Anyang-si (KR)

(72) Inventors: Ji Seob Park, Hwaseong-si (KR); Ji Ah Kim, Hwaseong-si (KR); Ji Yun Ha, Hwaseong-si (KR); Jin Ho Hwang, Hwaseong-si (KR); Young Min Kim, Hanam-si (KR); Jae Moon Jeong, Namyangju-si (KR)

(73) Assignees: HYUNDAI MOTOR COMPANY, Seoul (KR); KIA CORPORATION, Seoul (KR); ESP CO.,LTD, Ulsan (KR); SEOYON E-HWA CO., LTD., Anyang-si (KR)

(21) Appl. No.: 19/271,452

(22) Filed: Jul. 16, 2025

(30) Foreign Application Priority Data
Dec. 10, 2024 (KR) 10-2024-0182136

(51) Int. Cl. B60N 3/10

(52) U.S. Cl. CPC B60N 3/105

(57) ABSTRACT

A cup holder includes a base, a support portion level with a cover portion in a drawn-in state and selectively brought into contact with the bottom surface of a cup when in use, a holding portion into which the support portion is selectively inserted, and a drive unit configured to simultaneously move the support portion downward and the holding portion upward.

### CROSS-REFERENCE TO RELATED APPLICATION

This application claims, under 35 U.S.C. § 119(a), the benefit of and priority to Korean Patent Application No. 10-2024-0182136, filed on Dec. 10, 2024, the entire contents of which are incorporated herein by reference.

### TECHNICAL FIELD

The present disclosure relates to a cup holder. More particularly, the present disclosure relates to a cup holder that changes in height with simple manipulation by adopting a structure in which a holding portion surrounding the outer circumferential surface of a cup and a support portion supporting the bottom surface of the cup are moved away from each other.

### BACKGROUND

Generally, cup holder assembly systems are mounted at various spots at the front and back of a vehicle's interior for the convenience of drivers and passengers to safely store cups, cans or bottles containing beverages.

However, because current cup holder assembly systems do not include a separate support portion in a cup holder housing, which is a cup storage space, when a beverage can or cup is inserted into the cup holder housing having a diameter greater than that of the cup or can, a large space is created between them, causing a problem in which the beverage can or cup would shake and move in all directions due to the vibrations generated while the vehicle is travelling.

Whereas when there is not much space between the cup holder housing and the cup, it is difficult for the driver or passenger to take out the cup because the cup is tightly or snugly fit in the cup holder housing.

In addition to solving the above-mentioned problem, there has been a demand for a cup holder whose height is adjustable to match the length and size of the cup inserted therein by the height of the cup being fixed to fit the shape of the cup holder housing.

The above information disclosed in this Background section is only for enhancement of understanding of the background of the present disclosure, and therefore it may contain information that does not form the prior art that is already known to a person of ordinary skill in the art.

### SUMMARY OF THE DISCLOSURE

The present disclosure has been made in an effort to solve the above-described problems associated with the prior art, and an object of the present disclosure is to provide a cup holder that is not opened in a drawn-in state, and has a height to support a cup when in use.

Another object of the present disclosure is to provide a cup holder in which a holding portion and a support portion move away from each other through a single operation.

The objects of the present disclosure are not limited to the foregoing, and other objects of the present disclosure not mentioned herein may be understood based on the following description, and may be understood more clearly through the embodiments of the present disclosure. In addition, the objects of the present disclosure may be realized by means and combinations thereof indicated in the claims.

As an embodiment of the present disclosure, provided is a cup holder including: a base; a support portion positioned adjacent to a top surface of a cover portion in a drawn-in state and selectively brought into contact with a bottom surface of a cup; a holding portion into which the support portion is selectively inserted; and a drive unit configured to simultaneously move the support portion downward and the holding portion upward.

The cup holder may include a rod positioned on a bottom surface of the support portion, and a guide portion positioned on the base to allow the rod to be selectively inserted there into.

The drive unit may include at least one or more drive links rotatably positioned between a protrusion on the rod and a coupling portion of the holding portion, a base rod positioned on the base and configured to provide a rotation shaft of the drive link, and a guide groove in which the protrusion and the rotation shaft are positioned to be movable in response to the movement of the drive link

The rotation center point of the drive link may change depending on the position of the rotation shaft in the guide groove.

When the drive link rotates with respect to the coupling portion, the holding portion may move upward beyond the cover portion as the drive link moves in the height direction with respect to the rotation shaft, and the support portion may move downward along with the protrusion linked to another end of the drive link.

The cup holder may further include a guide rod positioned between the base and the cover portion and configured to guide the up-down movement of the holding portion.

According to another embodiment of the present disclosure, the drive unit may include a rotary gear portion connected to the base, a first gear portion placed on an outer side surface of the holding portion and engaged with the rotary gear portion, and a second gear portion engaged with the rotary gear portion by being connected to the support portion.

The first gear portion may protrude beyond a top surface of the cover portion in the height direction in response to the rotation of the rotary gear portion.

The second gear portion may move downward in the height direction of the cover portion.

The support portion and the holding portion may simultaneously move away from each other in the height direction.

The cup holder may include a frame connected to the second gear portion and connected to the support portion by passing through a slit in the holding portion.

The first gear portion and the second gear portion may have the same gear ratio.

Other aspects and embodiments of the present disclosure are discussed below.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are described below in detail with reference to certain embodiments thereof illustrated in the accompanying drawings which are given herein below by way of illustration only, and thus are not limitative of the present disclosure, and wherein:

FIG. 1 illustrates an armrest where a cup holder is placed, according to an embodiment of the present disclosure;

FIG. 2 illustrates the structure of a cup holder in a drawn-in state, according to an embodiment of the present disclosure;

FIG. 3 is an exploded perspective view illustrating the structure of a cup holder including a drive link, according to an embodiment of the present disclosure;

FIG. 4 is a side cross-sectional view of a cup holder including a drive link in a drawn-in state, according to an embodiment of the present disclosure;

FIG. 5 is a side cross-sectional view of a cup holder including a drive link in a drawn-out state, according to an embodiment of the present disclosure;

FIG. 6 is a side cross-sectional view of a cup holder including a rotary gear portion in a drawn-in state, according to another embodiment of the present disclosure; and

FIG. 7 is a side cross-sectional view of a cup holder including a rotary gear portion in a drawn-out state, according to another embodiment of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Hereinafter, embodiments of the present disclosure are described in detail with reference to the accompanying drawings. The embodiments of the present disclosure may be modified into various forms, and the scope of the present disclosure should not be construed as being limited to the following embodiments. The embodiments are provided to more completely explain the present disclosure to those having ordinary skill in the art.

In addition, terms such as “. . . portion,” “. . . unit,” “. . . housing,” and the like used in this specification each refer to a unit that processes at least one function or operation, and may be implemented as hardware or software or a combination thereof. Each “part”, “unit”, “module”, “component”, “device”, “element”, and the like may separately embody or be included with a processor and a memory, such as a non-transitory computer readable media, as part of the apparatus. When a part, component, unit, device, element, or the like of the present disclosure is described as having a purpose or performing an operation, function, or the like, the part, component, unit, device, or element should be considered herein as being “configured to” meet that purpose or to perform that operation or function.

It should be understood that, although the terms “first,” “second,” and the like may be used herein to describe various similar elements, these elements should not be construed as being limited by these terms.

Moreover, in this specification, the term “drawn out” means that the cup holder is driven to a position where a cup may be inserted into the cup holder, and the term “drawn in” means a state in which a support portion 200 constituting the cup holder is switched to a position level with a cover portion 10.

Furthermore, in this specification, the term “height direction” means an up-down direction in which a cup is inserted into a holding portion 300.

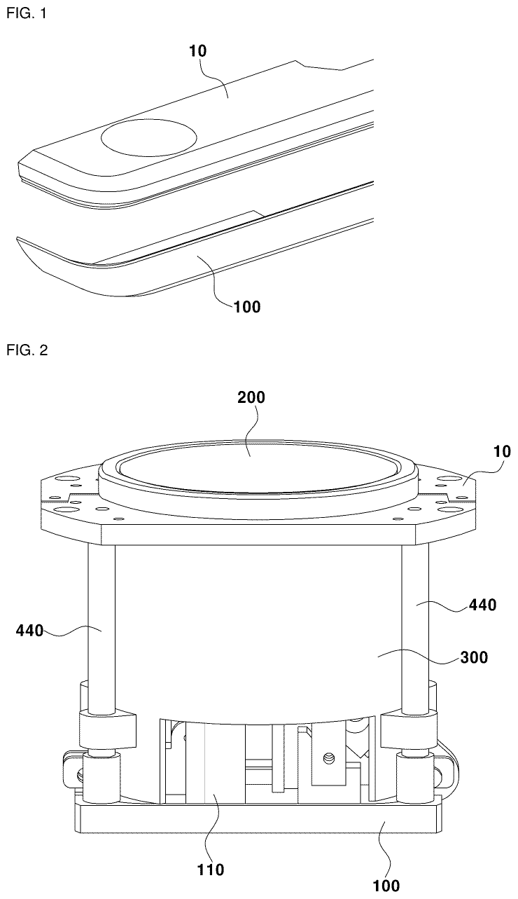

FIG. 1 illustrates an armrest structure including the cup holder according to the present disclosure.

The cup holder is placed on a base 100 placed at the lower end thereof and the upper end of the cup holder is placed at the inner side of an open cover. In the case of the illustrated armrest, the upper end of the armrest includes an area facing a user's arm, and the base 100 placed at the lower end of the armrest includes a component fixed to a vehicle body or the interior of the vehicle body.

The cup holder may be placed to be drawn into the insertion hole in the cover, or drawn out of the cover in response to the user's request. Although FIG. 1 illustrates the armrest as a structure including the cup holder, the cup holder of the present disclosure may be placed in any component fixed in the interior of the vehicle.

In the cup holder placed at the inner side of the insertion hole in a drawn-in state, a support portion 200 is positioned at a height corresponding to the insertion hole. Upon a user's request, the support portion 200 moves downward relative to an upward movement of the holding portion 300. In other words, there may be created a sufficient height for a cup to be inserted into the cup holder owing to the holding portion 300 being moved upward and the support portion 200 being moved downward.

FIG. 2 is a perspective view of the cup holder that is placed inside the insertion hole, according to an embodiment of the present disclosure.

The cup holder includes the base 100 fixed to the vehicle body at the lower end thereof, and the cover portion 10 having substantially the same height as the support portion 200 in the drawn-in state. The cup holder further includes the holding portion 300 having an annular or cylindrical shape elongated in a height direction and being placed inside the insertion hole at the bottom of the support portion 200. The holding portion 300 has a cavity greater than the outer circumferential surface of the support portion 200 so as to allow the support portion 200 to pass through the holding portion 300 when moving up and down in the height direction. In other words, according to an example where the support portion 200 and the holding portion 300 have circular cross sections, a diameter of the holding portion 300 is larger than a diameter of the support portion 200, such that the support portion 200 is configured to nest or move within the holding portion 300.

Furthermore, the cup holder includes a guide rod 440 positioned between the cover portion 10 and the base 100 to guide the up-down movement of the holding portion 300. In order to support the holding portion 300 when the support portion 200 and the holding portion 300 move up and down in linkage with each other, at least one or more guide rods 440 are provided. The guide rods 440, positioned between the cover portion 10 and the base 100, are at equal intervals along the outer circumferential surface of the holding portion 300.

A drive unit 400 is configured to simultaneously move the support portion 200 downward and the holding portion 300 upward. In one example, the holding portion 300 is configured to protrude outwardly of the cover portion 10 in a state where the upper end of the holding portion 300 and the top surface of the support portion 200 have a maximum distance from each other.

The holding portion 300 may include a locking portion configured to interfere with the top surface of the cover portion 10. With the locking portion, the holding portion 300 protruding outwardly of the cover portion 10 may be brought into contact with the top surface of the cover portion 10.

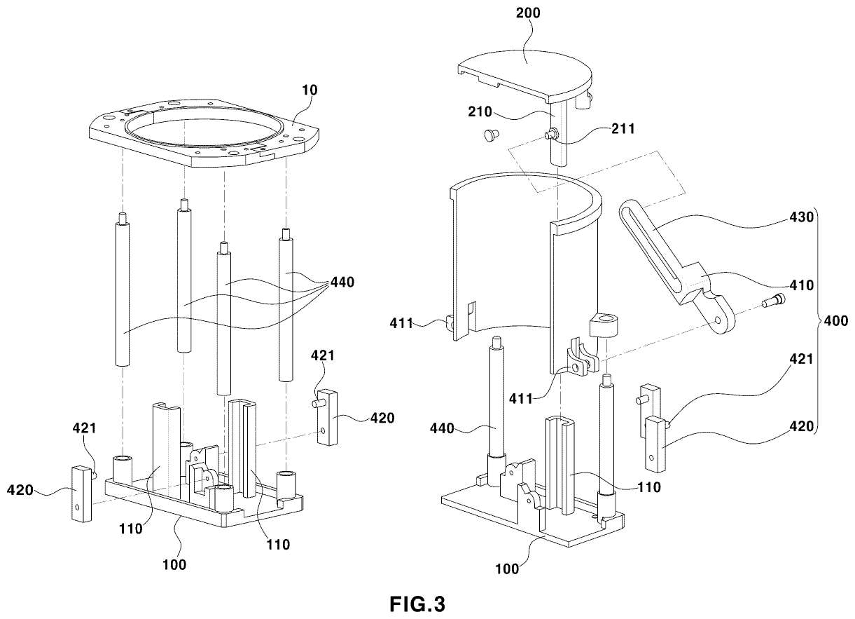

FIG. 3 is an exploded perspective view illustrating the structure of the cup holder disclosed in FIG. 2, according to an embodiment of the present disclosure.

The base 100 is a component fixed to the vehicle body and includes a guide portion 110 protruding from the top surface of the base 100. At least a portion of a rod 210 protruding from the bottom surface of the support portion 200 is inserted into the guide portion 110, and because of the guide portion 110, the support portion 200 may keep a horizontal state while moving downward and upward. In some examples, there may be provided at least one or more guide portions 110. In the present disclosure, two guide portions 110 are included at symmetrical positions, and the ends of respective rods 210 of the support portion 200 are inserted into the two guide portions 110, respectively. Furthermore, at least a portion of the rod 210 is kept inserted (i.e., retained) inside the guide portion 110.

According to one embodiment of the present disclosure, the drive unit 400, configured to apply upward and downward driving force to the support portion 200 and the holding portion 300, includes a drive link 410 rotatably linked to a protrusion 211 formed on the rod 210 protruding from the bottom surface of the support portion 200. The drive link 410 is also rotatably coupled or linked to a coupling portion 411 outwardly protruding from the holding portion 300. According to one example, there are provided two drive links 410, and the drive links 410 may be placed adjacent to each other at opposite sides with respect to the holding portion 300. Furthermore, the drive unit 400 also includes a base rod 420 coupled to the base 100, where the base rod 420 includes a rotation shaft 421 extending outwardly therefrom.

The drive link 410 has one portion (e.g., an upper portion) linked to the bottom portion of the support portion 200 and has another portion (e.g., lower portion) coupled to the coupling portion 411 of the holding portion 300, with the rotation shaft 421 positioned there between. With this configuration, the drive link 410 transmits force to move the support portion 200 and the coupling portion 411 opposite each other in the up-down direction.

Moreover, the drive link 410 includes a guide groove 430 having a long hole or oblong shape and into which both the protrusion 211 and the rotation shaft 421 are inserted. In other words, the protrusion 211 and the rotation shaft 421 are placed inside the guide groove 430, allowing the distance between the coupling portion 411 and the rotation shaft 421 and the distance between the coupling portion 411 and the protrusion 211 to be relatively changed as the holding portion 300 moves in the height direction.

In other words, in a state where the drive link 410 is rotated to be parallel to the ground, the protrusion 211 and the rotation shaft 421, which move along the long hole of the guide groove 430, have a minimum distance from the coupling portion 411. In a state where the cup holder is fully drawn out, the distance between the coupling portion 411 and the rotation shaft 421 and the distance between the coupling portion 411 and the protrusion 211 are the maximum (i.e., furthest apart).

Differently put, the position of the rotation shaft 421 in the drive link 410 may change through the guide groove 430, and both the protrusion 211 and the rotation shaft 421 may be placed inside the guide groove 430 so as to absorb the relative distance change. Therefore, the rotation center point (i.e., center of rotation) of the drive link 410 may change within the guide groove 430 depending on the amount of rotation of the drive link 410.

The two drive links 410 positioned with respect to the two mutually facing coupling portions 411 rotate in response to the user's request. The drive link 410 rotatably coupled to the coupling portion 411 rotates at one end positioned at the bottom of the support portion 200. In other words, the rod 210 formed on the bottom surface of the support portion 200 and the protrusion 211 of the rod 210 perform vertical movement in the height direction according to the movement of the guide groove 430 in the drive link 410. Furthermore, when the two drive links 410, positioned to face each other with respect to the holding portion 300, rotate as one unit, each of the two rods 210 extending downward from the bottom surface of the support portion 200 moves vertically downward together with a corresponding drive link 410.

Furthermore, the drive link 410 coupled to the coupling portion 411 rotates about the rotation shaft 421 on the base rod 420. One end of the drive link 410 positioned at the coupling portion 411 rotates with the rotation shaft 421 being the rotation center so as to move the holding portion 300 upward. When the holding portion 300 moves in the height direction, the rotation shaft 421 may be moved along the long hole inside the guide groove 430 so that the distance between the coupling portion 411 and the rotation shaft 421 may change.

As such, the support portion 200 and the holding portion 300 move opposite each other in the height direction in response to the rotation of the drive link 410 of the drive unit 400, providing a space into which a cup can be inserted.

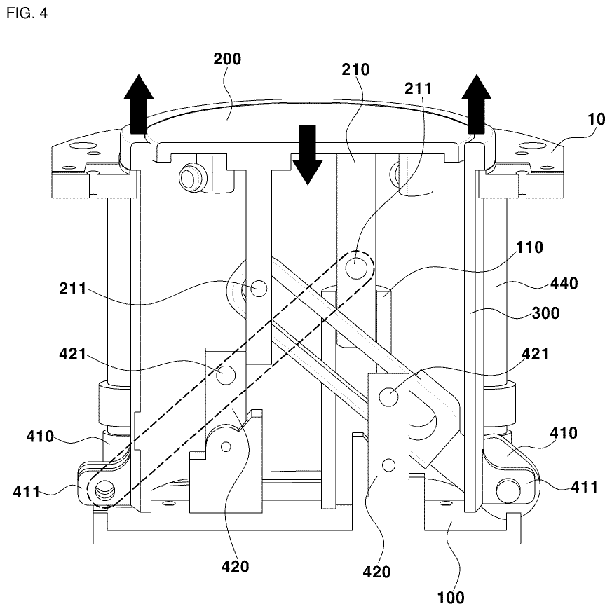

FIG. 4 is a cross-sectional view illustrating the positional relationship in the drive unit 400 in the drawn-in state of the cup holder, according to an embodiment of the present disclosure.

When the cup holder is drawn in, the support portion 200 is level with the cover (and substantially level with the cover portion 10). In other words, the support portion 200 is positioned to surround the open top surface of the holding portion 300 and is positioned on one surface corresponding to the cover.

The drive link 410 of the drive unit 400 is positioned between the protrusion 211 at the bottom of the support portion 200 and the coupling portion 411. One end of the drive link 410 facing the protrusion 211 is positioned higher than the coupling portion 411. A portion of the rod 210 protruding downward in the height direction from the bottom surface of the support portion 200 is inserted into the guide portion 110 on the base 100. In one example, the guide portion 110 of the present disclosure has one side open and the protrusion 211 of the rod 210 is positioned at the open side, and thus, even when the rod 210 is fully inserted into the guide portion 110, the protrusion 211 may be kept being inserted into the guide groove 430 in the drive link 410. In other words, the protrusion 211 remains inserted into the guide groove 430 even when the rod 210 is fully inserted into the guide portion 110. In the drawn-in state, the protrusion 211 may be positioned adjacent to one inner end of guide groove 430 in the drive link 410.

The base rod 420 protrudes from the top surface of the base 100 and provides the rotation shaft 421 of the drive link 410. The rotation shaft 421 may be positioned such that it is inserted into the guide groove 430 in the drive link 410.

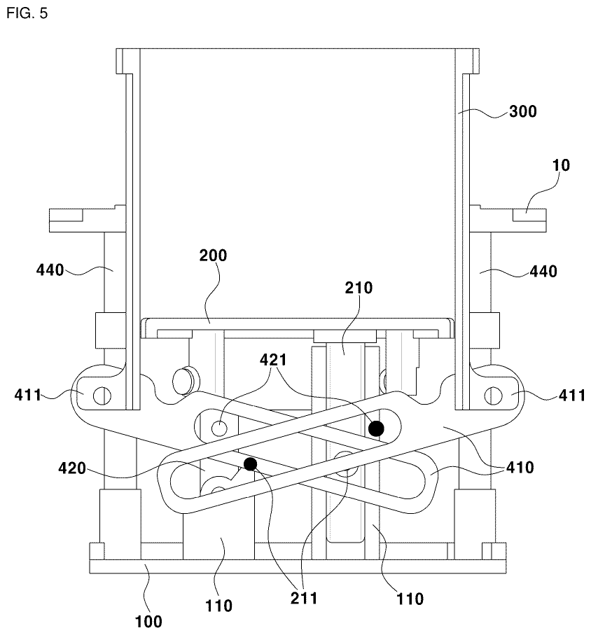

In comparison to the above, FIG. 5 illustrates the state of the cup holder being drawn out.

In the drawn-out state, the support portion 200 is moved downward to a position adjacent to the base 100, and the rod 210 is entirely inserted into the guide portion 110. Moreover, the holding portion 300 is moved upward in the height direction by the distance of the support portion 200 that has moved downward, and is positioned to protrude beyond the top surface of the cover portion 10.

The drive unit 400 is driven to move the support portion 200 downward and to move the holding portion 300 upward. Moreover, because the coupling portion 411 moves in the height direction as one unit with the holding portion 300, the drive link 410 rotatably connected to the coupling portion 411 is rotated so that another end of the drive link 410 moves downward with respect to the coupling portion 411.

The drive link 410 applies force to the protrusion 211 so that one end of the drive link 410 placed at the bottom of the support portion 200 moves downward with respect to the coupling portion 411. Furthermore, the protrusion 211 located at one end of the guide groove 430 in the drawn-in state is moved to an area adjacent to the center of the guide groove 430 by the drive link 410 being rotated.

In other words, one end of the drive link 410 adjacent to the coupling portion 411 with respect to rotation shaft 421 of the base rod 420 moves upward, and the guide groove 430 linked to the protrusion 211 moves downward.

As an embodiment of the present disclosure, the distance by which the support portion 200 is moved downward in the height direction may be substantially the same as the distance by which the holding portion 300 is moved upward beyond the cover portion 10.

As such, the present disclosure provides a cup holder structure in which the support portion 200 and the holding portion 300 simultaneously move in opposite directions in response to the rotation of the drive link 410, making it possible to hold a cup in a reduced amount of space.

Moreover, according to the present disclosure, the support portion 200 is flush with the top surface of the cover portion 10 in the drawn-in state, and thus the dented or depressed (i.e., cavity shaped) outline is not visible from the outside. In other words, in the drawn in state, the top of the support portion 200 and the top surface of the cover portion 100 are aligned (flush), giving the appearance of not being a cup holder (i.e., hiding the appearance of a cup holder).

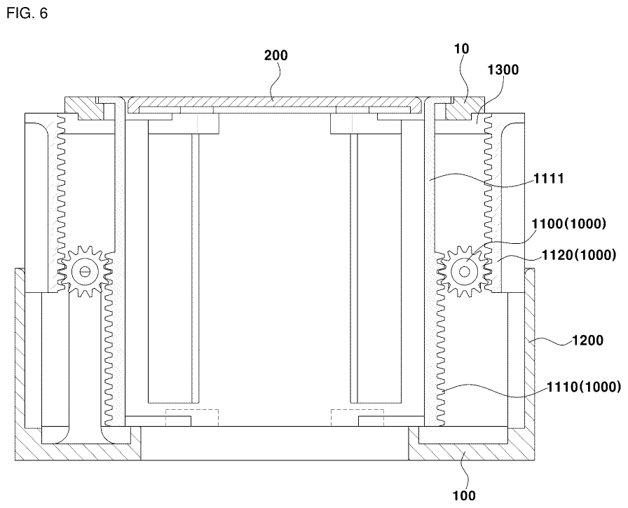

FIG. 6 illustrates a cup holder in which a support portion and a holding portion may move in opposite directions using a gear structure, according to a different embodiment.

In the different embodiment of the present disclosure as shown in FIG. 6, the cup holder includes a base fixed to the vehicle body at the lower end thereof, and the support portion 200 has substantially the same height as a cover portion 10 in a drawn-in state.

The cup holder further includes a holding portion 300 having an annular shape elongated in a height direction and being placed inside the insertion hole at the bottom of the support portion 200. The holding portion 300 has a cavity greater than the outer circumferential surface of the support portion 200 so as to allow the support portion 200 to pass through the holding portion 300 when moving up and down in the height direction.

A drive unit 1000 is configured to simultaneously move the support portion 200 downward and the holding portion 300 upward. In this example, the holding portion 300 protrudes outwardly of the cover portion 10 in a state of the upper end of the holding portion 300 and the top surface of the support portion 200 having a maximum distance from each other.

In this different embodiment of the present disclosure, the drive unit 1000 includes a rotary gear portion 1100 connected to the base and configured to rotate by receiving driving force from a driving portion (i.e., a source of a driving force). The drive unit 1000 includes a first gear portion 1110 placed on the outer side surface of the holding portion 300 and configured to convert the rotational force of the rotary gear portion 1100 into a force to move the holding portion 300 in the height direction by being mutually engaged with the rotary gear portion 1100. The drive unit 1000 also includes a second gear portion 1120 configured to move the support portion 200 up and down in response to the driving force of the rotary gear portion 1100 by being engaged with the support portion 200.

The rotary gear portion 1100 has a rotation shaft placed at an extension protruding from the base, and is configured to rotate in response to an operation of an external driving portion or a pressure from a user pressing the support portion 200. When the user presses the support portion 200, the second gear portion 1120 drives the rotary gear portion 1100 and the first gear portion 1110, moving the support portion 200 and the holding portion 300 opposite each other in the height direction.

The rotating rotary gear portion 1100 has opposite ends at which the first gear portion 1110 and the second gear portion 1120 are positioned, respectively. Because the first gear portion 1110 and the second gear portion 1120 have the same gear ratio, the amount of height-direction movement of the support portion 200 and the amount of height-direction movement of the holding portion 300 in response to the amount of rotation of the rotary gear portion 1100 are the same.

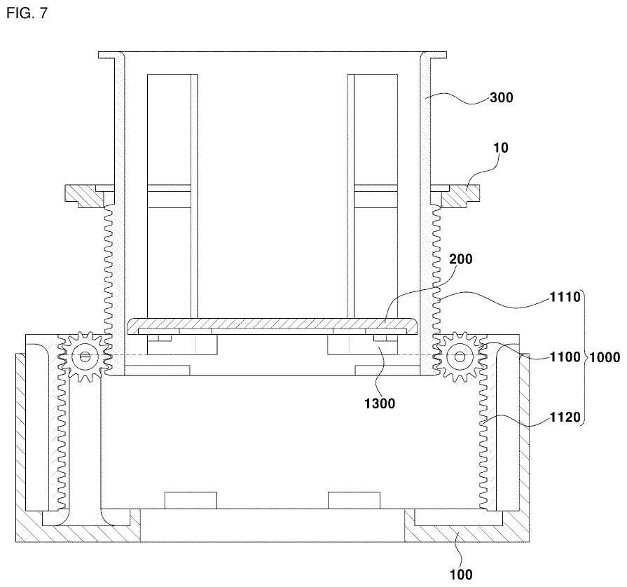

FIG. 7 illustrates the different embodiment of the present disclosure (i.e., that of FIG. 6) in which the cup holder is in a drawn-out state.

As illustrated in the drawing, when the driving force of a driving portion is applied to the rotary unit, the rotary gear portion 1100 applies a rotational force to the holding portion 300 so that the holding portion 300 in the drawn-in state as in FIG. 6 is moved upward in the height direction (to be in a drawn out state). At the same time, the second gear portion 1120 engaged with the support portion 200 moves downward along a guide portion 1200 of the base (see FIG. 6) by passing through a slit 1111 formed on an outer side surface of the holding portion 300 (see FIG. 6).

In other words, a frame 1300 of the support portion 200 including the second gear portion 1120 is coupled to the support portion 200 moving in the up-down direction inside the holding portion 300 through the slit 1111 in the holding portion 300, and the up-down movement of the frame 1300 may be guided along the guide portion 1200 of the base 100.

Furthermore, because the amount of downward movement of the support portion 200 and the amount of upward movement of the holding portion 300 in response to the driving force of the driving portion may be the same, the gear ratio and the number of gears of the first gear portion 1110 and the gear ratio and the number of gears of the second gear portion 1120 may be set to be the same.

Therefore, when the cup holder is drawn out, the holding portion 300 protrudes from the top surface of the cover portion 10 by a predetermined height and the support portion 200 moves downward by a predetermined height with respect to the bottom surface of the cover portion 10, providing a space to hold a cup.

As is apparent from the above description, the present disclosure may obtain the following effects by the configuration, combination, and operation relationship described above with the present embodiment.

The present disclosure provides a cup holder that is not opened when not in use and is drawn out when in use, thereby providing improved aesthetics to the interior of the vehicle.

Moreover, the present disclosure provides a cup holder having sufficient height to hold a cup through a structure in which a holding portion and a support portion move away from each other by a single operation, thereby improving usability.

The detailed description is merely illustrative of the present disclosure. In addition, the above description shows and describes embodiments of the present disclosure, but the present disclosure can be used in various other combinations, modifications, and environments. In other words, changes or modifications are possible within the scope of the idea of the disclosure disclosed herein, the scope of equivalents to the described disclosure, and/or the scope of ordinary skill or knowledge in the art. The embodiments describe the best state or mode for implementing the technical idea of the present disclosure, and various changes required for specific application fields and uses of the present disclosure are possible. Therefore, the detailed description of the present disclosure is not intended to limit the present disclosure to the disclosed embodiments. Also, the appended claims should be construed to include other embodiments.

What is claimed is:

1. A cup holder comprising:
a base;
a support portion positioned adjacent to a top surface of a cover portion in a drawn-in state and configured to be selectively brought into contact with a bottom surface of a cup;
a holding portion into which the support portion is configured to be selectively inserted; and
a drive unit configured to move the support portion and the holding portion in opposite directions.

2. The cup holder of claim 1, further comprising:
a rod positioned on a bottom surface of the support portion; and
a guide portion positioned on the base, the guide portion configured to allow the rod to be selectively inserted into the guide portion.

3. The cup holder of claim 1, wherein the drive unit comprises:
at least one or more drive links rotatably positioned between a protrusion on a rod extending away from a bottom surface of the support portion and a coupling portion of the holding portion;
a base rod positioned on the base and configured to provide a rotation shaft of the drive link; and
a guide groove in which the protrusion and the rotation shaft are positioned and configured to be movable in response to a movement of the drive link.

4. The cup holder of claim 3, wherein the drive link has a rotation center point, wherein the rotation center point is configured to change depending on a position of the rotation shaft in the guide groove.

5. The cup holder of claim 3, wherein, when the drive link is configured to rotate with respect to the coupling portion,
wherein the holding portion is configured to move upward beyond the cover portion as the drive link moves in a height direction with respect to the rotation shaft, and
wherein the support portion is configured to move downward along with the protrusion linked to another end of the drive link.

6. The cup holder of claim 3, further comprising a guide rod positioned between the base and the cover portion and configured to guide an up-down movement of the holding portion.

7. The cup holder of claim 1, wherein the drive unit comprises:
a rotary gear portion connected to the base;
a first gear portion disposed on an outer side surface of the holding portion and engaged with the rotary gear portion; and
a second gear portion engaged with the rotary gear portion and connected to the support portion.

8. The cup holder of claim 7, wherein the first gear portion protrudes beyond a top surface of the cover portion in the height direction in response to a rotation of the rotary gear portion.

9. The cup holder of claim 8, wherein the second gear portion moves downward in the height direction of the cover portion.

10. The cup holder of claim 9, wherein the support portion and the holding portion simultaneously move away from each other in the height direction.

11. The cup holder of claim 7, further comprising a frame connected to the second gear portion and connected to the support portion, the frame being disposed in a slit in the holding portion.

12. The cup holder of claim 7, wherein the first gear portion and the second gear portion have a same gear ratio.

13. The cup holder of claim 1, wherein the opposite directions are a downward direction and an upward direction, such that the drive unit is configured to move the support portion in the downward direction and the holding portion in the upward direction.

14. The cup holder of claim 1, wherein the drive unit is configured to move the support portion and the holding portion simultaneously.
